(19) United States
(12) Patent Application Publication
(10) Pub. No.: US 2004/0001718 A1
(43) Pub. Date: Jan. 1, 2004

(54) Course wavelength division multiplexed optical network

(76) Inventors: Manyalibo Joseph Matthews, Jersey City, NJ (US); Doutje T. Van Veen, Berkeley Heights, NJ (US)

Correspondence Address: Lucent Technologies Inc., Docket Administrator (Room 3J-219), 101 Crawfords Corner Road, Holmdel, NJ, 07733-3030, US

(21) Appl. No.: 10/183,597

(22) Filed: Jun. 26, 2002

(51) Int. Cl. H04J 14/08

(52) U.S. Cl. 398/98

(57) ABSTRACT

A course wavelength division multiplexed optical network for transmitting time division multiplexed optical signals is disclosed. For downstream transmission, an optical line terminal generates a plurality of single wavelength optical signals having embedded time division multiplexed data streams. The single wavelength optical signals have channel spacing of at least approximately 20 nm. The single wavelength optical signals are multiplexed onto a multi-wavelength optical signal for transmission via an optical fiber. The multi-wavelength optical signal is demultiplexed into its component single wavelength signals using a course wavelength division demultiplexer. Each of the single wavelength signals is then split into multiple identical single wavelength signals for transmission to end users. Each of the users extracts its associated data stream from its assigned time slot. For upstream transmission, the end users generate data using a media access algorithm appropriate for time division multiplexed signals and transmits the data upstream on a single wavelength. The single wavelength signals from end users for a particular wavelength are combined in the network to form a plurality of single wavelength time division multiplexed signals. These plurality of single wavelength time division multiplexed signals are them multiplexed onto a multi-wavelength optical signal for transmission back to the optical line terminal.

### TECHNICAL FIELD

The present invention relates generally to optical networking. More particularly, the present invention relates to a course wavelength division multiplexed optical network for transmitting time division multiplexed signals.

### BACKGROUND OF THE INVENTION

Optical networks use light to transmit information between points of the network using an optical fiber to direct the light to the desired location. Various techniques for transmitting information via optical networks are well known. One of the overall goals of such a network is to increase the capacity of the network such that more information may be transmitted over each fiber. In an access network, in which information is transmitted to network end users, one way to measure capacity is the number of end users which can be provisioned with a given bandwidth.

One technique for servicing multiple end users is through use of wavelength division multiplexing (WDM), in which multiple wavelengths of light are multiplexed on a single fiber for transmission through the network. Such systems provide for high bandwidth transmission between the transmission facility and receivers. At the transmitter, various wavelengths are generated and they are multiplexed onto a single fiber. The fiber then leaves the transmission facility and the multiplexed signal travels along the outside transmission facilities toward the customer premises (generally an optical network unit (ONU)). Prior to entering the ONU, the multiplexed optical signal is demultiplexed, such that each ONU receives the appropriate wavelength associated with the particular ONU.

One problem with using WDM in an access network is the limit on the number of end users which may be serviced off of a single WDM optical fiber. It has been found that, while up to approximately 32 end users may be serviced off of a single optical fiber using standard devices, a network actually implementing such capacity would be very expensive to construct. First, the optical bandwidth which can be transmitted via an optical fiber is generally limited to a bandwidth of approximately 260 nm falling into two sub-bands (1270 nm-1350 nm and 1460 nm-1640 nm). In order to share this optical bandwidth among 32 end users, each end user would be allocated approximately 8.1 nm of wavelength. An optical network of the type in which each user is allocated only a relatively small optical bandwidth is known as a dense WDM (DWDM) system. Because of the narrow optical bandwidth available to each user in a DWDM network, expensive optical components are necessary to implement such a network. For example, the lasers used in optical network communications tend to suffer from wavelength drift away from their nominal transmission wavelength. In order design a network in which each user was allocated only 8.1 nm of bandwidth, the optical transmitters would need to include wavelength stabilized (i.e., cooled) distributed feedback (DFB) lasers. Such DFB lasers do not drift very much from their nominal transmit wavelength, and are thus appropriate for a DWDM system. The problem with DFB lasers, however, is that they tend to be expensive relative to non-wavelength stabilized lasers (e.g. Fabry Perot lasers).

Another problem with DWDM systems is related to the wavelength drift of the passive optical components in the transmission network. In an access network, the multiplexed signals are demultiplexed using an optical demultiplexer which is designed to receive the multiple wavelengths at one input port, and demultiplex the wavelengths such that a particular wavelength exits at each of a plurality of output ports of the demultiplexer. Passive optical network components in the transmission network, such as WDM demultiplexers, are often located in the outside transmission facility and as such, are subject to environmental conditions. In particular, the temperature of the WDM demultiplexers will vary with changes in the ambient outside temperature. A problem arises in that it is a characteristic of such devices that their passband characteristics change with a change in temperature of the component. Thus, as the outside temperature changes, the passbands of the component will shift such that the passbands of the output ports will not be centered on the appropriate wavelengths. This results in reduced power received by the end users on their assigned wavelength.

The problem of passband drift of passive optical components in a DWDM network is discussed in further detail in co-pending U.S. patent application Ser. No. 10/128,823 entitled Modulation Phase Shift To Compensate For Optical Passband Shift.

Thus, as described above, provisioning of service to approximately 32 end users from a single fiber in an optical network is possible using DWDM techniques, but it is currently an expensive solution.

Another technique for servicing multiple end users from a single fiber is through use of time division multiplexing (TDM), in which a single wavelength of light is used to transmit to multiple end users and each end user is assigned a different time slot for its transmissions. In such a network, the signal being transmitted by a single optical fiber is split among 32 end users using power splitters. A power splitter functions such that the signal that is present on an input port is split among, and outputted on, each of a number of output ports. Thus, in order to split the signal on a single fiber among 32 end users, the signal may be split into 8 signals using a 1×8 splitter, and each of the resulting 8 signals may be further split into 4 signals using a 1×4 splitter. However, one problem in this technique is that each splitter imposes a loss on the signal it is splitting. For example, insertion losses for 1×4 and 1×8 splitters are typically 7 and 10 dB respectively. This loss is high considering typical loss budgets of 20-25 dB for access networks. Thus, while serving up to 32 users is feasible using the power splitting technique, serving more than 32 users requires more sophisticated components and becomes expensive.

Another problem with serving multiple users using a TDM system is that upstream communication from the end users to the network head end require that the end users utilize a specific media access control scheme so that the upstream transmissions do not interfere with each other. In order to implement an acceptable upstream capability, an end user transmitting laser should only be transmitting an optical signal during that user's allocated time slot. During other times, the transmitting laser should not be transmitting any optical signal. However, most low cost lasers do not turn completely off when they are in a standby mode. Instead, most lasers transmit at some low power level (which is higher than 0 power level). The problem with using such low cost lasers is that multiple end user lasers transmitting at a low power level will combine to interfere with the particular user that is transmitting during its allocated time slot.

The above problem can be solved by equipping the end user premises with so-called burst mode lasers, which transmit zero power level when they are in the off state. However, these lasers are very expensive. Even if burst mode lasers are used, the power-on time (the time it takes the laser to go from an off state to a transmitting state) and the power-off time (the time it takes the laser to go from a transmitting state to an off state) are not negligible, and add to the overhead of the system and thereby reduce the overall upstream capacity. While burst mode lasers with very short power-on and power-off times are available, such characteristics add significant cost to the lasers.

### SUMMARY OF THE INVENTION

The present invention solves the problems of the prior art by providing a network architecture and method for operation which allows for the provisioning of high speed optical data channels to end users without the need for expensive specialized optical components.

In accordance with the principles of the present invention, a combination of so-called course wavelength division multiplexing is used in combination with time division multiplexing to provide high speed data to end users. As described in further detail below, course wavelength division multiplexing utilizes optical signal channels having wavelength spacing sufficient to allow for moderate wavelength drift in both transmitting lasers and in optical components (e.g., multiplexers and demultiplexers). This tolerance to wavelength drift allows for the use of relatively inexpensive optical components. However, the use of wider wavelength spacing for the optical signal channels reduces the number of available channels given a limited available optical spectrum. The present invention solves the problem of a limited number of channels by encoding multiple data streams onto each optical channel using time division multiplexing techniques. This novel combination of course wavelength division multiplexing used in combination with time division multiplexing provides high bandwidth data to end users and solves problems of prior art systems.

In accordance with one embodiment of the invention, downstream data is provided to end users utilizing course wavelength division demultiplexers in combination with optical signal splitters in order to provision the data from an optical line terminal at a head end to end users. More particularly, a course wavelength division demultiplexer receives a multi-wavelength optical signal from an optical line terminal, separates out each of the signal's component wavelengths, and outputs each wavelength on a separate output port. Each of the single wavelength optical signals output from an output port of the demultiplexer is provided to an optical splitter which splits the signal into a plurality of identical signals to be transmitted to a plurality of end users. Each of the identical signals is a single wavelength optical signal which comprises embedded TDM data streams. Each of the end users receiving the single wavelength optical signal has a particular time slot assigned to it and is thus able to extract its data from the optical signal.

In accordance with another embodiment of the invention, upstream data is provided to an optical line terminal utilizing course wavelength division multiplexers in combination with optical combiners in order to provision the data from end users to an optical line terminal at a head end. More particularly, a plurality of optical combiners each receive single wavelength optical signals from a plurality of end users. Each combiner combines its received signals into one single wavelength optical signal and transmits the combined signal to a course wavelength division multiplexer. The multiplexer combines its received signals into a multi-wavelength optical signal and transmits it to an optical line terminal. In the upstream direction, each of the end users sharing a single wavelength must transmit in accordance with a TDM media access control algorithm such that the end user transmitted signals do not interfere with each other when they are combined into one single wavelength optical signal at the combiner.

As described above, the novel use of course WDM in combination with TDM allows for advantageous optical data transmission. One advantage is the ability to use relatively inexpensive optical components. For example, optical transmitters used in a network configured in accordance with the present invention may be implemented using un-cooled distributed feedback lasers. The wavelength drift associated with such lasers is well tolerated in a network in accordance with the present invention. In addition, the optical multiplexers and demultiplexers may be located in the outside transmission facility without the need to temperature stabilize such components. Once again, any wavelength drift associated with changes in ambient temperature of these components is well tolerated in a network in accordance with the present invention.

These and other advantages of the invention will be apparent to those of ordinary skill in the art by reference to the following detailed description and the accompanying drawings.

### BRIEF DESCRIPTION OF THE DRAWINGS

FIG. 1 shows one embodiment of an optical network incorporating the principles of the present invention;

FIG. 2 illustrates embedded TDM data streams within optical data signals; and

FIG. 3 shows further details of the optical line terminal shown in FIG. 1.

### DETAILED DESCRIPTION

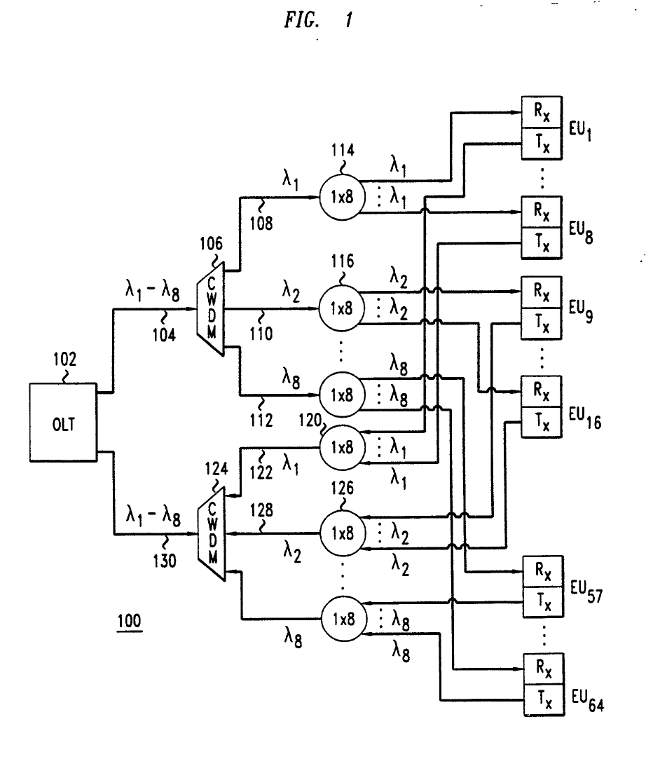

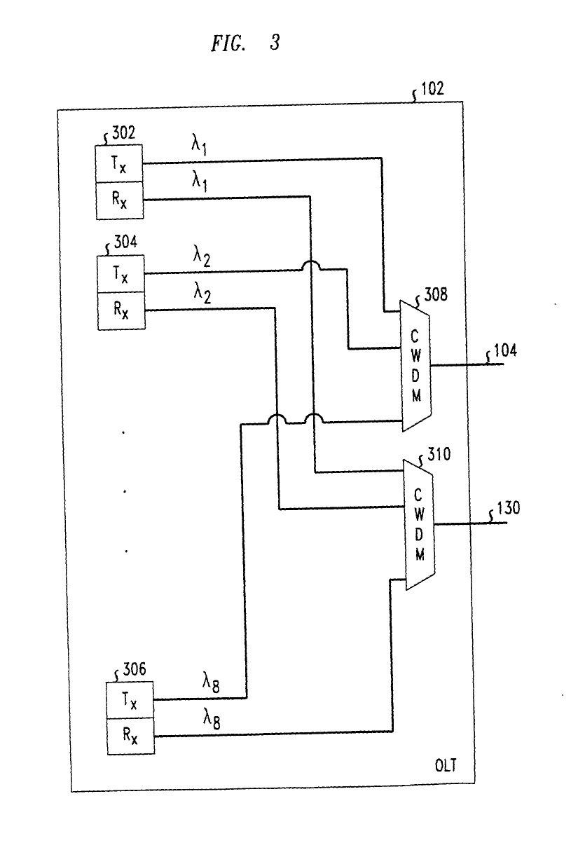

One embodiment of an optical network 100 incorporating the principles of the present invention is shown in FIG. 1. The network comprises an optical line termination point (OLT) 102 which transmits optical signals to, and receives optical signals from, 64 end users (EU₁-EU₆₄). Details of the OLT 102 will be described in further detail below in conjunction with FIG. 3. OLT 102 is connected to a wavelength division demultiplexer 106 via optical fiber 104 for downstream transmission from the OLT 102 to end users. In order to avoid the necessity of using high cost optical components which are resistant to wavelength drift, wavelength division demultiplexer 106 is a so-called course wavelength division demultiplexer. As used herein, a course wavelength division demultiplexer is a wavelength division demultiplexer having optical passbands of at least 20 nm spacing between passband centers. By using course wavelength division multiplexing (CWDM) rather than DWDM, the passbands of the demultiplexer are wider and therefore are more tolerant of the moderate wavelength drift of less expensive transmitting lasers. In addition, another advantage of the use of CWDM is that a course wavelength division demultiplexer can be located in the outside transmission facility without the need for temperature stabilization. The passband drift associated with changes in ambient temperature can be tolerated because of the relatively passbands.

However, while the use of CWDM allows the use of less expensive components, it also limits the number of unique wavelengths that may be used for data transmission. Assuming a usable optical bandwidth having passband centers in the range of 1470-1610 nm, the use of CWDM allows for 8 unique wavelengths. It is reasonable to assume that each unique wavelength channel on fiber 104 can transmit data at a data rate of approximately 1 Gigabit second (Gbps).

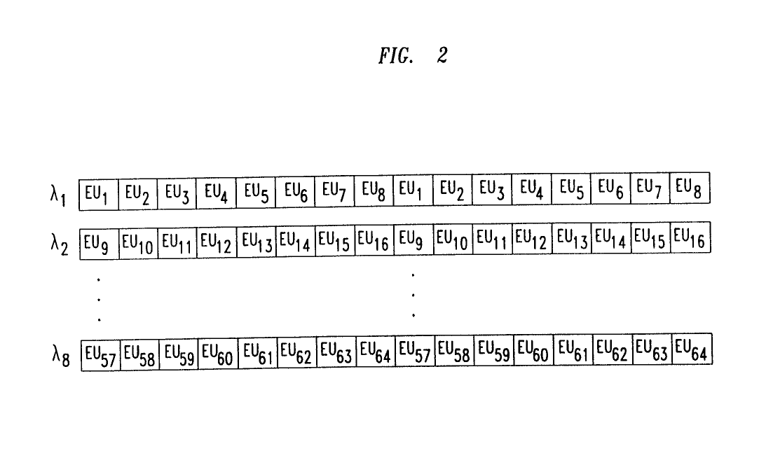

Since 1 Gbps is a higher data rate than is needed by end users in most applications, each wavelength channel may be shared by multiple users. This sharing of wavelengths is accomplished by using time division multiplexing to multiplex multiple data streams onto each of the unique wavelength channels. TDM is well known in the art, the details of which will not be described herein. Thus, for example, 8 different data streams (associated with 8 different end users) may be multiplexed onto each of the individual wavelength channels being transmitted by optical fiber 104, thus giving each end user a data rate of 125 Mbps (including overhead). This multiplexing of data is further illustrated by FIG. 2 which shows 8 CWDM optical signals (λ₁-λ₈), each transmitting 8 individual TDM data streams. For example, the optical signal on wavelength 1 (λ₁) is carrying the TDM data streams for end users EU₁-EU₈, the optical signal on λ₂ is carrying the TDM data streams for end users EU₉-EU₁₆, . . . the optical signal on λ₈ is carrying the TDM data streams for end users EU₅₇-EU₆₄. Thus, the use of a CWDM optical signal with an embedded TDM data stream allows for the provisioning of 64 125 Mbps data streams to multiple (64 in the particular embodiment shown) end users.

Returning now to FIG. 1, the downstream optical signal comprising wavelengths λ₁-λ₈ are provided to course wavelength division demultiplexer 106 via optical fiber 104. Course wavelength division demultiplexer 106 receives the signals, and outputs each of wavelengths λ₁-λ₈ on a separate output port. As shown in FIG. 1, λ₁ is output to optical fiber 108, λ₂ is output to optical fiber 110, . . . , λ₈ is output to optical fiber 112. It is noted that the present description describes a single wavelength signal (e.g., λ₁) as being output by the demultiplexer. However, as used herein, and as would be readily recognized by one skilled in the art, reference to a single wavelength optical signal actually refers to a signal having an optical spectrum within some given optical bandwidth which, for purposes of optical data transmission, is treated as a single wavelength channel and may be considered as a single wavelength. As described above, each of the individual optical signals contains 8 TDM data streams associated with 8 different end users. For example, optical signal on optical fiber 108 contains the data streams associated with EU₁-EU₈. Thus, the signal on optical fiber 108 is provided to an optical power splitter 114 which receives the optical signal on an input port, splits the signal, and outputs the signal on a plurality of output ports to each of end users EU₁-EU₈ as shown in FIG. 1. Similarly, optical signal 2 on optical fiber 110 contains the data streams associated with EU₉-EU₁₆. Thus, the signal on optical fiber 110 is provided to optical power splitter 116 which splits the signal and provides it to each end users EU₉-EU₁₆. Each of the remaining optical signals are provided to an appropriate optical power splifter which splits the signal and provides it to the appropriate end users.

Upstream transmissions from the end users to the OLT 102 is handled in a manner similar to that of the downstream signals. Each of end users EU₁-EU₈ transmits upstream signals on wavelength λ₁ to combiner 120. Each of the upstream signals are combined by combiner 120 onto optical fiber 122 for further transmission to course wavelength division multiplexer 124. Since each end user EU₁-EU₈ transmits its upstream data on the same wavelength, and each of the these transmissions are combined onto a single optical fiber 122, the upstream transmissions of end user EU₁-EU₈ must be coordinated so that they do not interfere with each other. This coordination of upstream transmissions may be accomplished using any of a number of well known TDM media access control (MAC) algorithms which are well known in the art, for example as described in G. N. M. Sudhakar, M. Kavehrad and N. D. Georganas, “Access Protocols for Passive Optical Star Networks”, Computer Networks and ISDN Systems Vol. 26, pp. 913-930 (1994).

Similarly, each of end users EU₉-EU₁₆ transmits upstream signals on wavelength λ₂ to combiner 126. Each of these upstream signals are combined by combiner 126 onto optical fiber 128 for further transmission to course wavelength division multiplexer 124. All upstream signals are transmitted to course wavelength division multiplexer 124 in a similar manner. All upstream signals are multiplexed onto optical fiber 130 and provided to OLT 102.

Further details of OLT 102 are shown in FIG. 3. OLT 102 includes eight optical transceivers (three of which are specifically shown in FIG. 3 as 302, 304, 306) for transmitting and receiving optical signals from end users. Although not shown in FIG. 3, OLT 102 would be connected to data sources from which the data to be transmitted to the end users would be received. For example, transceiver 302 would receive data to be transmitted to end users EU₁-EU₈, transceiver 304 would receive data to be transmitted to end users EU₉-EU₁₆, . . . transceiver 306 would receive data to be transmitted to end users EU₅₇-EU₆₄. The data received by these transceivers needs to be multiplexed into appropriate time slots (as described above in conjunction with FIG. 2) for transmission to the appropriate end user. The provisioning of data to OLT 102, as well as the assignment of TDM time slots for such data, would be well known to one of ordinary skill in the art of data networks, the details of which will not be described herein. The transceivers each transmit an optical signal on one wavelength to course wavelength division multiplexer 308, which in turn multiplexes the optical signals onto optical fiber 104 for further transmission as described above.

The details of the transmitter portions of the transceivers would be well known by one of ordinary skill in the art of optical networks, the details of which will not be described herein. As described above, one of the advantages of the present invention is that the use of CWDM techniques allows the network to be more tolerant of wavelength drift of transmitting lasers. As such, less expensive lasers may be used. In one embodiment, the lasers used in the transmitting portions of the transceivers 302, 304, 306 may be un-cooled distributed feedback lasers.

Optical signals are received by the OLT 102 via optical fiber 130. The signal received on optical fiber 130 is a multiplexed optical signal including wavelengths λ₁ . . . λ₈. The received multiplexed optical signal is demultiplexed by course wavelength demultiplexer 310. Individual wavelength signals are provided to the individual transceivers as shown in FIG. 3. More particularly wavelength λ₁ is provided to transceiver 302, wavelength λ₂ is provided to transceiver 304, . . . wavelength λ₈ is provided to transceiver 306. The optical signal received by each transceiver includes TDM data streams associated with multiple end users as described above in conjunction with FIG. 2. The data streams are extracted from the signal in accordance with well known TDM techniques and the individual data streams are processed as appropriate for the particular application.

Thus, in accordance with the principles of the present invention, a combination of CWDM and TDM techniques are used to provision broadband optical signals in a manner which solves problems associated with prior art techniques. More particularly, the use of CWDM instead of DWDM allows for relatively inexpensive optical components because wavelength drift of the lasers, and passband drift of the demultiplexers, is not of critical concern because of the relatively wide spacing between wavelengths of the optical channels.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. For example, the embodiment described herein utilizes 8 wavelengths in order to provision optical signals to end users. However, the principles of the present invention may be applied to an optical network which uses any number of optical wavelengths to provision optical signals to end users. Further, it is noted that although the embodiment of FIG. 1 shows each end user using the same wavelength for upstream and downstream transmission, it is not required that each end user using the same wavelength for upstream and downstream transmission. In addition, one skilled in the art would readily recognize that the various design parameters described herein could be changed while still utilizing the principles of the present invention. Such design parameters include, without limitation, the optical spectrum used for transmission, the number of unique optical channels, the width of each of the unique optical channels, the number of end users, and the bandwidth or data rate allocated to each end user. Further, while reference is made herein to optical splitters and combiners, one skilled in the art would recognize that the functionality of combining and splitting could be implemented using a single device (generically called a 1×N coupler), which is often referred to as a combiner or splitter depending upon its use in a network. Similarly, while reference is made herein to optical multiplexers and demultiplexers, one skilled in the art would recognize that the functionality of multiplexing and demultiplexing could be implemented using a single device (generically called a 1×N coupler), which is often referred to as a multiplexer or demultiplexer depending upon its use in a network.

We claim:

1. An optical communication apparatus comprising:
a course wavelength division demultiplexer for receiving a multi-wavelength optical signal and for outputting a plurality of single wavelength optical signals; and
a plurality of optical splitters, each of said optical splitters receiving one of said single wavelength optical signals and outputting the single wavelength optical signal on each of a plurality of output ports;
wherein each of said single wavelength optical signals comprises an embedded time division multiplexed signal.

2. The optical communication apparatus of claim 1 wherein said course wavelength division demultiplexer has optical passbands of approximately 20 nm spacing.

3. The optical communication apparatus of claim 1 wherein said course wavelength division demultiplexer is non-temperature stabilized.

4. The optical communication apparatus of claim 1 further comprising an optical line terminal for transmitting said multi-wavelength optical signal, wherein said optical line terminal comprises a plurality of optical transceivers, each transmitting a single wavelength optical signal.

5. The optical communication apparatus of claim 4 wherein said optical transceivers further comprise un-cooled distributed feedback lasers.

6. A method for optical signal communication comprising the steps of:
demultiplexing a received multi-wavelength optical signal and outputting a plurality of single wavelength optical signals, wherein said single wavelength optical signals have separations of at least approximately 20 nm and wherein each of said single wavelength optical signals comprises an embedded time division multiplexed signal;
splitting each of said single wavelength optical signals into a plurality of single wavelength optical signals.

7. The method of claim 6 wherein said step of demultiplexing is performed using a non-temperature stabilized course wavelength division demultiplexer.

8. An optical communication apparatus comprising:
a first optical combiner for receiving a single wavelength optical signal from a first plurality of end users and for combining said single wavelength optical signals into a first single wavelength optical signal having embedded time division multiplexed data streams of each of said first plurality of end users;
a second optical combiner for receiving a single wavelength optical signal from a second plurality of end users and for combining said single wavelength optical signals into a second single wavelength optical signal having embedded time division multiplexed data streams of each of said second plurality of end users;
a course wavelength division multiplexer for receiving said first and second single wavelength optical signals and for outputting a multi-wavelength optical signal to an optical line terminal.

9. The optical communication apparatus of claim 8 wherein said course wavelength division multiplexer has optical passbands of approximately 20 nm spacing.

10. The optical communication apparatus of claim 8 wherein said course wavelength division multiplexer is non-temperature stabilized.

11. A method for optical signal communication comprising the steps of:
receiving a single wavelength optical signal from a first plurality of end users and combining said single wavelength optical signals into a first single Matthews 2-2 13 wavelength optical signal having embedded time division multiplexed data streams of each of said first plurality of end users;
receiving a single wavelength optical signal from a second plurality of end users and combining said single wavelength optical signals into a second single wavelength optical signal having embedded time division multiplexed data streams of each of said second plurality of end users;
multiplexing said first and second single wavelength optical signals and outputting a multi-wavelength optical signals, wherein said single wavelength optical signals have separations of at least approximately 20 nm; and
transmitting said multi-wavelength optical signal to an optical line terminal.

12. The method of claim 11 wherein said step of multiplexing is performed using a non-temperature stabilized course wavelength division multiplexer.

13. A method for operation of an optical line terminal comprising the steps of:
generating a plurality of single wavelength signals having separations of at least approximately 20 nm and each comprising a plurality of embedded time division multiplexed data streams; and
multiplexing said plurality of single wavelength signals to generate a multi-wavelength optical signal.

14. The method of claim 13 wherein said step of generating is performed using at least one un-cooled distributed feedback laser.
